(19) United States
(12) Patent Application Publication
(10) Pub. No.: US 2021/0152039 A1
(43) Pub. Date: May 20, 2021

(54) STATOR, MOTOR, COMPRESSOR, AND REFRIGERATING AND AIR CONDITIONING APPARATUS

(71) Applicant: Mitsubishi Electric Corporation, Tokyo (JP)

(72) Inventor: Atsushi ISHIKAWA, Tokyo (JP)

(21) Appl. No.: 17/256,598

(22) PCT Filed: Aug. 3, 2018
(86) PCT No.: PCT/JP2018/029212

§ 371 Date: Dec. 28, 2020

(51) Int. Cl. H02K 1/16; H02K 1/27; H02K 21/14; F25B 31/02

(52) U.S. Cl. CPC H02K 1/16; F25B 31/026; H02K 21/14; H02K 1/276

(57) ABSTRACT

A stator includes a stator core and a plurality of segment coils fixed to the stator core by wave winding. The stator core includes a first tooth and a second tooth that is adjacent to the first tooth. The first tooth includes a first main part and a first end part. The second tooth includes a second main part and a second end part. When a straight line passing through an axis and a center of the outer end of the first main part is defined as L1, a straight line passing through the axis and a center of the outer end of the second main part is defined as L2, and a straight line passing through the axis and a halfway point between the first end part and the second end part is defined as L3, and letting θ1 be an angle between the straight line L1 and the straight line L3, and letting θ2 be an angle between the straight line L2 and the straight line L3, the stator satisfies θ1>θ2.

### CROSS REFERENCE TO RELATED APPLICATION

This application is a U.S. national stage application of International Application No. PCT/JP2018/029212 filed on Aug. 3, 2018, the contents of which are incorporated herein by reference.

### TECHNICAL FIELD

The present invention relates to a stator of a motor.

### BACKGROUND

As coils to be fixed to a stator of a motor, coils formed by distributed winding or concentrated winding using winding wire such as copper wire or aluminum wire are generally used. In a process for manufacturing such coils, a large space is required between teeth of a stator core to wind windings around the teeth. Therefore, a motor including coils formed by distributed winding or concentrated winding tends to be designed at a large size. Under the circumstances, coils formed by a combination of a plurality of conductors (also called segment coils or conductor segments) have been proposed (see, for example, patent reference 1). Since the use of such coils formed by a combination of a plurality of conductors makes it easy to fit the coils into slots of the stator core, the stator and the motor can easily be downsized advantageously.

### PATENT REFERENCE

Patent Reference 1: Japanese Patent Application Publication No. 2017-93097

In the motor including the downsized stator, however, when the rotation speed of the motor is increased, the current supplied to the coils increases, and copper loss thus occurs. Moreover, when the rotation speed of the motor is increased, since the frequency of this current gets higher, there is a problem in that iron loss in the stator core increases. In the conventional technique, therefore, it is difficult to reduce the iron loss and the copper loss in the stator while the stator is downsized.

### SUMMARY

It is an object of the present invention to reduce iron loss and copper loss in a stator while the stator is downsized.

A stator according to the present invention is provided as a stator to be disposed outside a rotor to rotate around an axis, the stator including:

a stator core including a plurality of teeth and a plurality of slots that are adjacent to the plurality of teeth, respectively; and

a plurality of segment coils fixed to the stator core by wave winding,

the stator core including:

a first tooth of the plurality of teeth, the first tooth including a first main part extending in a first radial direction and a first end part located on an inner side with respect to the first main part in the first radial direction, the first end part extending in a circumferential direction; and

a second tooth of the plurality of teeth, the second tooth being adjacent to the first tooth and including a second main part extending in a second radial direction and a second end part located on an inner side with respect to the second main part in the second radial direction, the second end part extending in the circumferential direction,

wherein the plurality of slots are six times as many as magnetic poles of the rotor,

in a plane perpendicular to the axis, a downstream side of the first end part in a rotation direction of the rotor is longer than an upstream side of the first end part in the rotation direction,

in the plane, a downstream side of the second end part in the rotation direction is longer than an upstream side of the second end part in the rotation direction, and

when a straight line passing through the axis and a center of an outer end of the first main part in the first radial direction in e the plane is defined as L1, a straight line passing through the axis and a center of an outer end of the second main part in the second radial direction in the plane is defined as L2, and a straight line passing through the axis and a halfway point between the first end part and the second end part in the plane is defined as L3, and letting θ1 be an angle between the straight line L1 and the straight line L3 in the plane, and letting θ2 be an angle between the straight line L2 and the straight line L3 in the plane, the stator satisfies θ1>θ2.

According to the present invention, it is possible to reduce iron loss and copper loss in a stator while the stator is downsized.

### BRIEF DESCRIPTION OF THE DRAWINGS

FIG. 1 is a sectional view schematically illustrating the structure of a motor according to Embodiment 1 of the present invention.

FIG. 2 is a plan view schematically illustrating the structure of a rotor core.

FIG. 3 is a perspective view schematically illustrating the structure of a coil formed by a plurality of segment coils.

FIG. 4 is a perspective view schematically illustrating one segment coil.

FIG. 5 is a plan view schematically illustrating the structure of a stator core.

FIG. 6 is an enlarged view schematically illustrating the structure of teeth illustrated in FIG. 5.

FIG. 7 is a diagram schematically illustrating the structure of teeth of a stator in a motor taken as a Comparative Example.

FIG. 8 is a diagram illustrating flows of magnetic flux in the motor including the teeth illustrated in FIG. 7.

FIG. 9 is a diagram illustrating the magnetic flux density at the end part of the tooth illustrated in FIG. 7.

FIG. 10 is a diagram illustrating the magnetic flux density at the end part of the tooth of the motor according to Embodiment 1.

FIG. 11 is a sectional view schematically illustrating the structure of a compressor according to Embodiment 2.

FIG. 12 is a diagram schematically illustrating the configuration of an air conditioner according to Embodiment 3.

### DETAILED DESCRIPTION

### Embodiment 1

In an x-y-z orthogonal coordinate system illustrated in each drawing, the z-axis direction (z-axis) indicates a direction parallel to an axis Ax of a motor 1, the x-axis direction (x-axis) indicates a direction perpendicular to the z-axis direction (z-axis), and the y-axis direction (y-axis) indicates a direction perpendicular to both the z-axis direction and the x-axis direction. The axis Ax serves as the center of rotation of a rotor 2. The direction parallel to the axis Ax will also be referred to as the “axial direction of the rotor 2” or simply as the “axial direction” hereinafter. The radial direction indicates a direction perpendicular to the axis Ax. The x-y plane indicates a plane perpendicular to the axial direction.

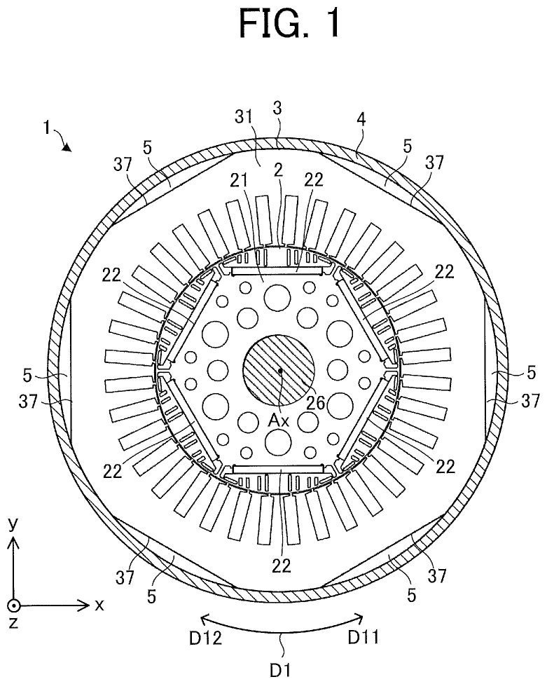

FIG. 1 is a sectional view schematically illustrating the structure of the motor 1 according to Embodiment 1 of the present invention. An arrow D1 indicates the circumferential direction of a stator 3 about the axis Ax. The arrow D1 also indicates the circumferential direction of the rotor 2 about the axis Ax. The circumferential directions of the rotor 2 and the stator 3 will also be simply referred to as the “circumferential direction” hereinafter. An arrow D11 corresponding to one head of the arrow D1 indicates the rotation direction of the rotor 2. An arrow D12 corresponding to the other head of the arrow D1 indicates a direction reverse to the rotation direction of the rotor 2.

The motor 1 includes the rotor 2 and the stator 3. The motor 1 may further include a housing 4 to cover the stator 3, as illustrated in FIG. 1.

In this Embodiment, the motor 1 is designed as, for example, a three-phase motor. More specifically, the motor 1 is designed as a permanent magnet synchronous motor (also called a brushless DC motor) such as an interior permanent magnet motor.

The rotor 2 is rotatably disposed inside the stator 3. An air gap is formed between the rotor 2 and the stator 3. The rotor 2 rotates about the axis Ax. The rotor 2 includes a rotor core 21, at least one permanent magnet 22, and a shaft 26.

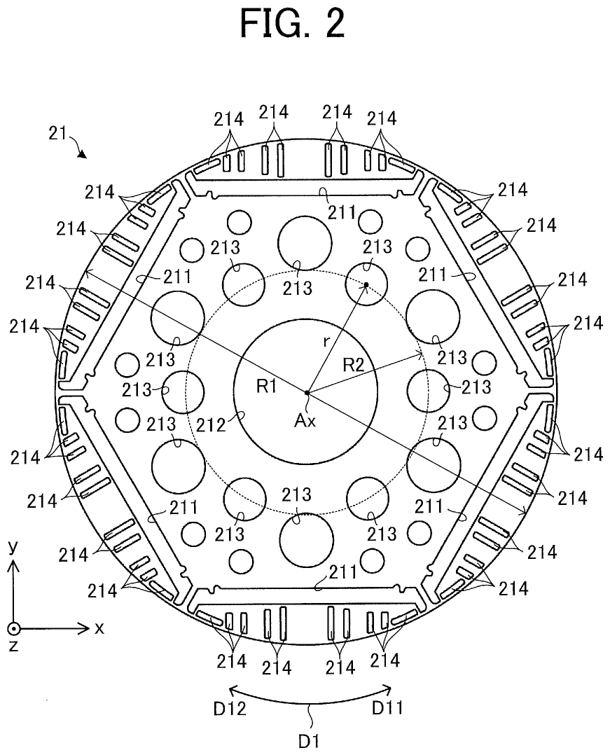

FIG. 2 is a plan view schematically illustrating the structure of the rotor core 21.

The rotor core 21 is formed by, for example, annular electrical steel sheets laminated in the axial direction. Therefore, the rotor core 21 has an annular shape in the x-y plane.

The rotor core 21 includes a plurality of magnet insertion holes 211, a shaft insertion hole 212, and at least one hole 213. The rotor core 21 may further include at least one slit 214 formed outside each magnet insertion hole 211 in the radial direction.

The plurality of magnet insertion holes 211, for example, are arranged in the circumferential direction. At least one permanent magnet 22 is inserted into each magnet insertion hole 211. Each magnet insertion hole 211 runs through the rotor core 21 in the axial direction.

In the example illustrated in FIG. 2, six magnet insertion holes 211 are arranged in the circumferential direction. In this Embodiment, one permanent magnet 22 is inserted into each magnet insertion hole 211. Therefore, the rotor 2 includes six permanent magnets 22. At least one permanent magnet 22 inserted into each magnet insertion hole 211 forms one magnetic pole on the rotor 2. In this Embodiment, therefore, the rotor 2 has six magnetic poles.

Each permanent magnet 22 uses, for example, a flat rare-earth sintered magnet containing Nd (neodymium) and Dy (dysprosium). The rare-earth magnet has a high residual magnetic flux density or remanence and a high coercive force or coercivity. It is, therefore, possible to improve the resistance to demagnetization in the rotor 2 and, in turn, to provide a highly efficient motor 1.

The shaft insertion hole 212 is formed at the center of the rotor core 21 in the x-y plane. The shaft 26 is inserted into the shaft insertion hole 212.

Each hole 213 extends in the axial direction. In the x-y plane, each hole 213 has a circular shape. When, for example, the motor 1 is used as a driving source for a compressor, each hole 213 is used as a through hole to pass a refrigerant through it in the compressor.

Letting ϕ be the diameter R1 of the rotor core 21, and r be the distance from the axis Ax to the center of the hole 213 in the x-y plane, the relationship between the diameter ϕ and the distance r satisfies ϕ/4≤r. The distance r from the axis Ax to the center of at least one hole 213 of the plurality of holes 213 need only be ϕ/4 or more. With this structure, since at least one hole 213 can be located near the permanent magnet 22, the permanent magnet 22 can be effectively cooled.

In the example illustrated in FIG. 2, the distance r from the axis Ax to the center of each hole 213 is ϕ/4 or more, for all the holes 213. In FIG. 2, the radius R2 of a circle indicated by a broken line is ϕ/4. In other words, in FIG. 2, the centers of all the holes 213 are located outside the circle having the radius R2 indicated by the broken line. This makes it possible to more effectively cool the permanent magnets 22.

The stator 3 is disposed outside the rotor 2. The stator 3 includes a stator core 31 and a plurality of segment coils 32. In the example illustrated in FIG. 1, a coil 30 (that is, the plurality of segment coils 32) is omitted from the stator core 31.

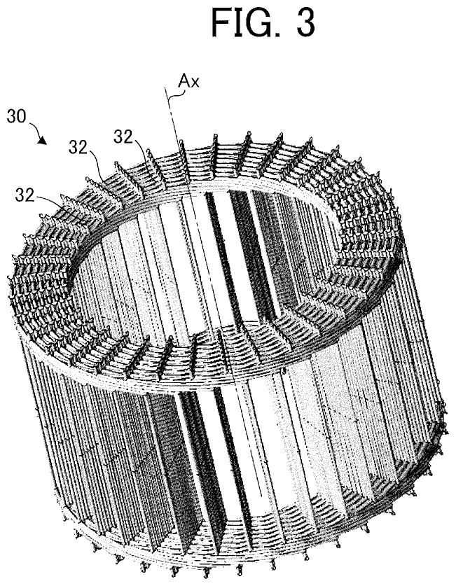

FIG. 3 is a perspective view schematically illustrating the structure of the coil 30 formed by the plurality of segment coils 32.

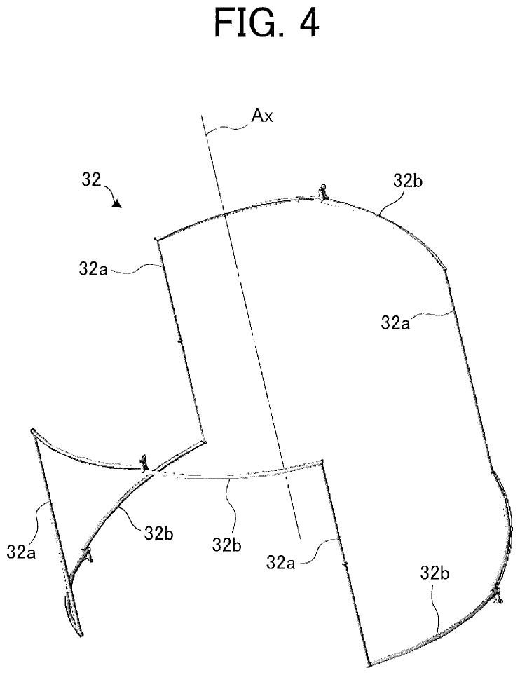

FIG. 4 is a perspective view schematically illustrating one segment coil 32.

The coil 30 is formed by the plurality of segment coils 32. The plurality of segment coils 32 are fixed to the stator core 31 by wave winding. With this configuration, the coil 30 is formed. In other words, the stator 3 includes the coil 30 formed by the plurality of segment coils 32.

Each segment coil 32 includes a first portion 32a extending in the axial direction, and second portions 32b located at the ends of the coil 30 in the axial direction. The first portion 32a is inserted into a slot 33 formed between teeth 34 adjacent to each other. The second portions 32b form the coil ends of the coil 30.

Each segment coil 32 is formed by, for example, a conductor such as copper or aluminum, and an insulating coating wound around the conductor. Each segment coil 32 has refrigerant resistance. The plurality of segment coils 32 are connected to each other by welding. Each segment coil 32 has, for example, a circular or quadrangular cross-section.

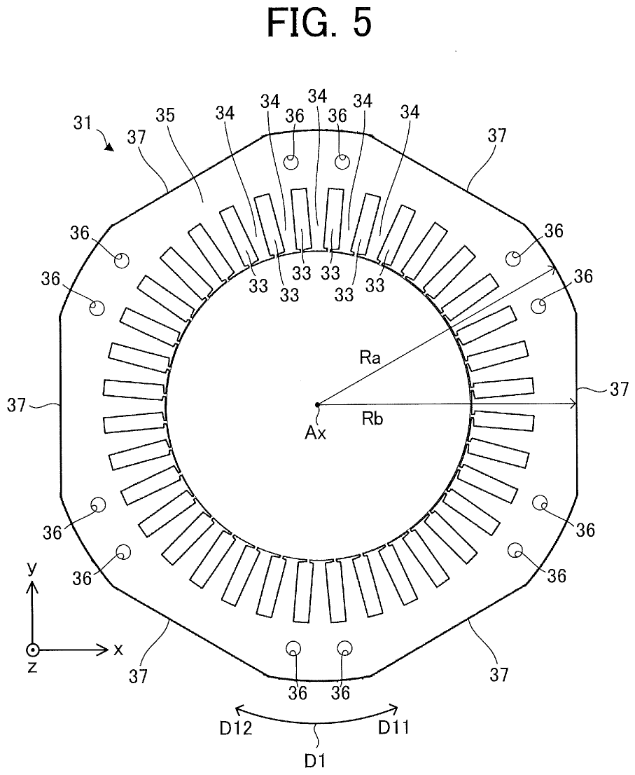

FIG. 5 is a plan view schematically illustrating the structure of the stator core 31.

The stator core 31 includes a yoke 35 extending in the circumferential direction, a plurality of teeth 34 extending from the yoke 35 in the radial direction, and a plurality of slots 33.

The stator core 31 further includes at least one recessed portion 37 formed on the outer circumferential surface of the stator core 31, and a plurality of holes 36 extending in the axial direction.

In the x-y plane, the stator core 31 has a maximum radius Ra and a radius Rb smaller than the maximum radius Ra. With this structure, a void 5 is formed between the stator 3 (more specifically, the recessed portion 37 of the stator core 31) and the housing 4, as illustrated in FIG. 1. In the example illustrated in FIG. 1, six voids 5 are formed between the stator 3 and the housing 4.

In the x-y plane, the radius Rb represents the minimum distance from the axis Ax to the recessed portion 37. In the example illustrated in FIG. 5, the recessed portion 37 is formed in a linear shape, but it may be formed in an arc or polygonal shape in the x-y plane. Each hole 36 extends in the axial direction.

The plurality of slots 33 are adjacent to the plurality of teeth 34, respectively. The plurality of slots 33 are six times as many as magnetic poles on the rotor 2. In other words, the number of slots 33 is six times the number of magnetic poles on the rotor 2. In this Embodiment, the number of slots 33 is set to 36, and the number of magnetic poles on the rotor 2 is set to six.

The stator core 31 is formed by, for example, annular electrical steel sheets laminated in the axial direction. Therefore, the stator core 31 has an annular shape in the x-y plane. Each electrical steel sheet is stamped into a predetermined shape. The thickness of each electrical steel sheet is, for example, 0.25 mm to 0.5 mm. The electrical steel sheets are fastened together by caulking.

When, for example, the motor 1 is used as a driving source for a compressor, each void 5 and each hole 36 are used as flow paths to pass a refrigerant through them in the compressor. This makes it possible to effectively cool the motor 1 in the compressor.

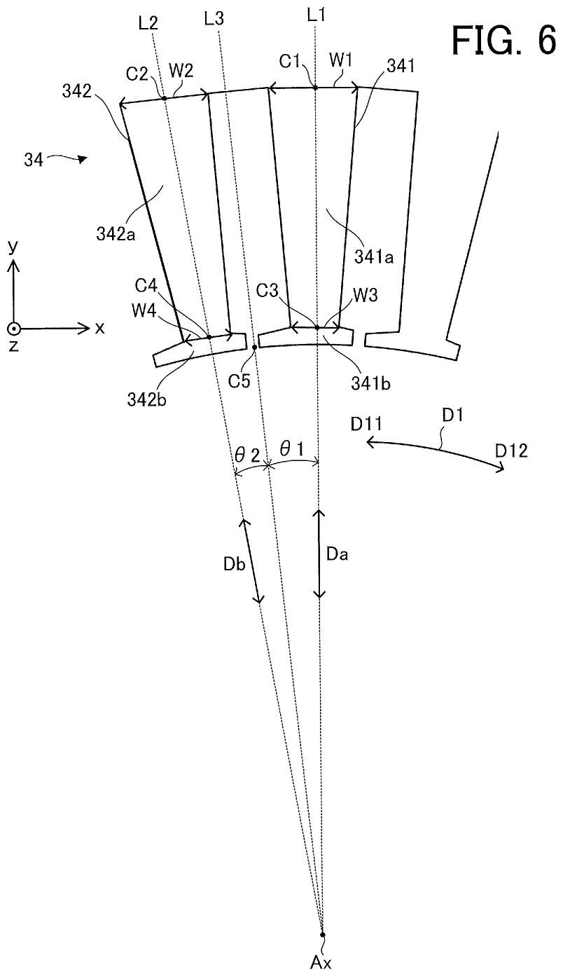

FIG. 6 is an enlarged view schematically illustrating the structure of the teeth 34 illustrated in FIG. 5.

As illustrated in FIG. 6, when one tooth of the plurality of teeth 34 is set as a first tooth 341, another tooth of the plurality of teeth 34, adjacent to the first tooth 341, is determined as a second tooth 342. In the example illustrated in FIG. 6, the second tooth 342 is located on a downstream side with respect to the first tooth 341 in the rotation direction D11.

The first tooth 341 includes a first main part 341a and a first end part 341b. In the x-y plane, the first main part 341a extends from the yoke 35 in the radial direction (to be also referred to as a first radial direction Da hereinafter). In other words, the first main part 341a extends inwards in the radial direction from the yoke 35. The first end part 341b is located on an inner side with respect to the first main part 341a in the radial direction and extends in the circumferential direction.

The second tooth 342 includes a second main part 342a and a second end part 342b. In the x-y plane, the second main part 342a extends from the yoke 35 in the radial direction (to be also referred to as a second radial direction Db hereinafter). In other words, the second main part 342a extends inwards in the radial direction from the yoke 35. The second end part 342b is located on an inner side with respect to the second main part 342a in the radial direction and extends in the circumferential direction.

In the respective teeth 34, portions corresponding to the first main part 341a and the second main part 342a will also be simply referred to as “main bodies” hereinafter. Similarly, in the respective teeth 34, portions corresponding to the first end part 341b and the second end part 342b will also be simply referred to as “end parts” hereinafter.

In FIG. 6, a straight line L1 represents a straight line passing through the axis Ax and a center C1 of the outer end of the first main part 341a in the first radial direction Da within the x-y plane. More specifically, the center C1 represents the center of a portion having a width W1 at the outer end of the first main part 341a in the x-y plane. The straight line L1 may even represent a straight line passing through the axis Ax and a center C3 of the inner end of the first main part 341a in the first radial direction Da within the x-y plane. In this case, the center C3 represents the center of a portion having a width W3 at the inner end of the first main part 341a in the x-y plane.

A straight line L2 represents a straight line passing through the axis Ax and a center C2 of the outer end of the second main part 342a in the second radial direction Db within the x-y plane. The straight line L2 may even represent a straight line passing through the axis Ax and a center C4 of the inner end of the second main part 342a in the second radial direction Db within the x-y plane. In this case, the center C4 represents the center of a portion having a width W4 at the inner end of the second main part 342a in the x-y plane.

A straight line L3 represents a straight line passing through the axis Ax and a halfway point C5 between the first end part 341b and the second end part 342b in the x-y plane.

In FIG. 6, the angle θ1 represents the angle between the straight line L1 and the straight line L3 in the x-y plane. The angle θ2 represents the angle between the straight line L2 and the straight line L3 in the x-y plane. In this case, the stator 3 satisfies θ1>θ2.

In the x-y plane, the shape of the first end part 341b is asymmetrical. More specifically, a portion of the first end part 341b extending from the straight line L1 to the downstream side in the rotation direction D11 is longer than a portion of the first end part 341b extending from the straight line L1 to the upstream side in the rotation direction D11, as illustrated in FIG. 6. In other words, in the x-y plane, the downstream side of the first end part 341b in the rotation direction D11 is longer than the upstream side of the first end part 341b in the rotation direction D11.

Similarly, in the x-y plane, the shape of the second end part 342b is asymmetrical. More specifically, a portion of the second end part 342b extending from the straight line L2 to the downstream side in the rotation direction D11 is longer than a portion of the second end part 342b extending from the straight line L2 to the upstream side in the rotation direction D11, as illustrated in FIG. 6. In other words, in the x-y plane, the downstream side of the second end part 342b in the rotation direction D11 is longer than the upstream side of the second end part 342b in the rotation direction D11.

With this structure, the relationship between the angles θ1 and θ2 satisfies θ1>θ2.

The effects of the stator 3 will be described below.

The coil 30 of the stator 3 is formed by the plurality of segment coils 32. In a process for manufacturing the stator 3, the segment coils 32 are inserted into the slots 33 and fixed in position by welding. It is, therefore, possible to more easily form the coil 30, regardless of the shape of the stator core 31, than in a method for winding lead wire such as copper wire or aluminum wire around teeth.

The degree of freedom in size of the region between the end parts of teeth 34 adjacent to each other, that is, a slot opening is higher in a method for forming the coil 30 by wave winding than in a method for concentrically winding a winding. More specifically, in the method for concentrically winding a winding, the width of the slot opening in the circumferential direction needs to be set larger than the diameter of one winding. In the method for fixing the plurality of segment coils 32 to the stator core 31 by wave winding, however, the segment coils 32 can be inserted into the slots 33 in the axial direction. In the stator 3, therefore, the width of the slot opening in the circumferential direction can be set small, and the motor characteristics can thus be improved.

The density of the coil 30 can be set higher in the method for forming the coil 30 by wave winding than in the method for concentrically winding a winding. This makes it possible to enhance the efficiency of the motor 1 and to downsize the motor 1. In other words, the use of the plurality of segment coils 32 fixed by wave winding makes the stator 3 be downsized and consequently the motor 1 can be downsized.

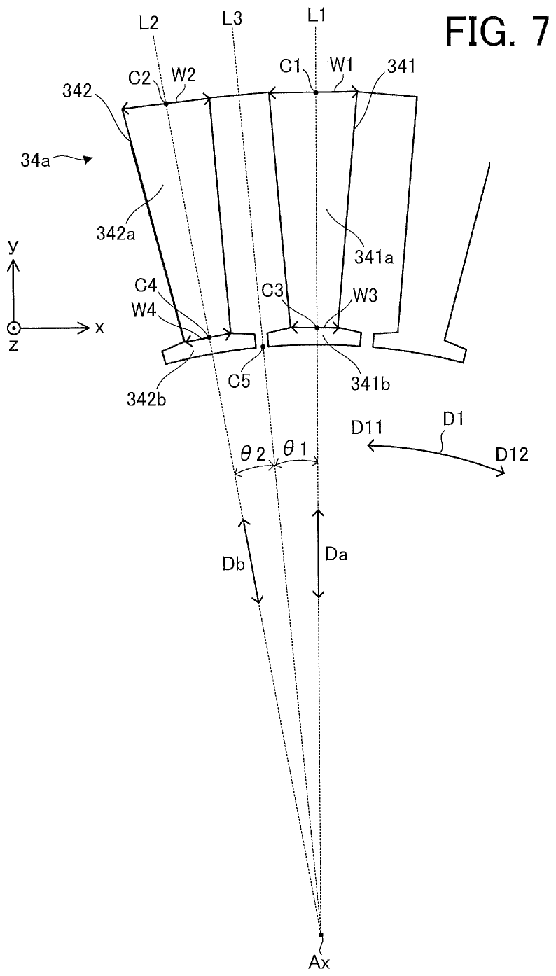

FIG. 7 is a diagram schematically illustrating the structure of teeth 34a of a stator in a motor as a Comparative Example.

The shape of the tooth 34a of the stator illustrated in FIG. 7 in the x-y plane is symmetrical. In other words, in the x-y plane, the shapes of the upstream and downstream sides of the end part in the rotation direction D11 are the same as each other. Therefore, in the Comparative Example illustrated in FIG. 7, the angles θ1 and θ2 are equal to each other.

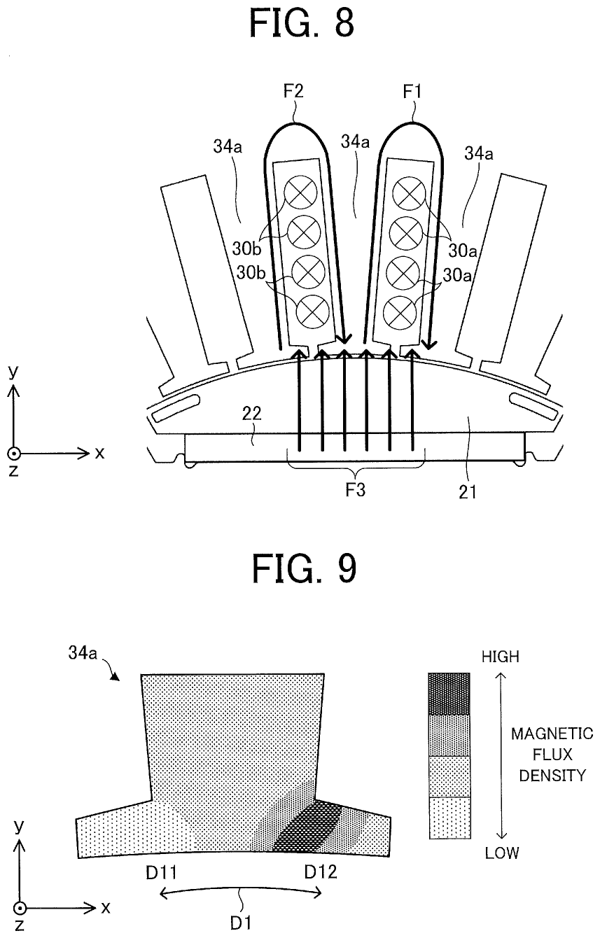

FIG. 8 is a diagram illustrating flows of magnetic flux in the motor including the teeth 34a illustrated in FIG. 7.

Arrows F1 and F2 (to be also referred to as magnetic fluxes F1 and F2, respectively, hereinafter) indicate the directions of magnetic fluxes generated by currents (also called armature currents) flowing through coils 30a and 30b, respectively, at a certain moment. Arrows F3 indicate the direction of magnetic flux from the permanent magnet 22. In the example illustrated in FIG. 8, the phase of the armature current and that of the induced voltage are the same as each other.

FIG. 9 is a diagram illustrating the magnetic flux density at the end part of the tooth 34a illustrated in FIG. 7.

As illustrated in FIGS. 8 and 9, since the direction of the magnetic flux F2 and the direction of the magnetic flux F3 are opposite to each other on the downstream side of the end part of the tooth 34a in the rotation direction D11, the magnetic flux density lowers. Since, however, the direction of the magnetic flux F1 and the direction of the magnetic flux F3 are the same as each other on the upstream side of the end part of the tooth 34a in the rotation direction D11, the magnetic flux density rises, and this causes magnetic saturation. This phenomenon is called a “cross-magnetization effect,” which is caused by armature reaction. When this phenomenon occurs, magnetic saturation is more likely to occur on the upstream side of the end part of the tooth 34a, and iron loss is thus more likely to increase. Therefore, iron loss is more likely to increase in the stator of the motor according to the Comparative Example.

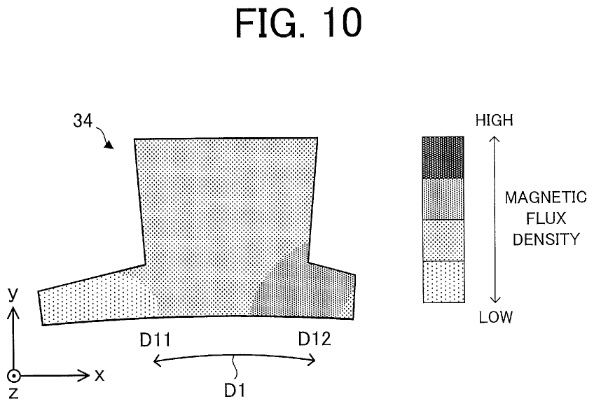

FIG. 10 is a diagram illustrating the magnetic flux density at the end part of the tooth 34 of the motor 1 according to this Embodiment.

In this Embodiment, the relationship between the angles θ1 and θ2 satisfies θ1>θ2. With this structure, the magnetic resistance is high on the upstream side of the end part of the tooth 34, and the magnetic saturation is thus reduced. As a result, the iron loss occurring on the upstream side of the end part of the tooth 34 in the rotation direction D11 can be reduced, as illustrated in FIG. 10. Furthermore, reducing the magnetic saturation on the upstream side of the end part of the tooth 34 makes it easy for the magnetic flux to pass through the end part of the tooth 34 on the upstream side. As a result, effects of increasing the effective magnetic force and reducing copper loss can also be obtained.

As described above, with the motor 1 according to this Embodiment, it is possible to downsize the stator and to reduce iron loss and copper loss in the stator.

Since the motor 1 according to Embodiment 1 includes the stator 3, the same effects as the above-mentioned effects of the stator 3 can be obtained in the motor 1.

### Embodiment 2

A compressor 6 according to Embodiment 2 of the present invention will be described below.

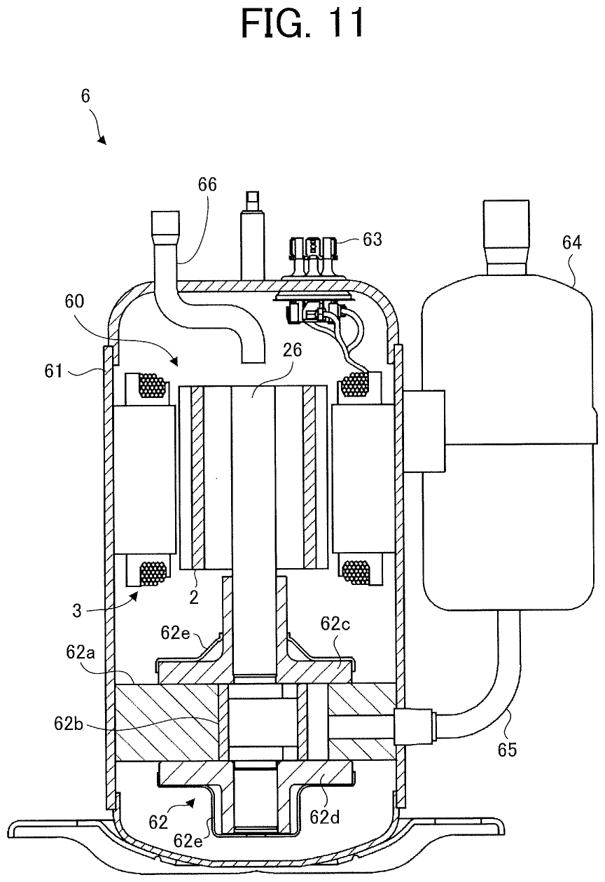

FIG. 11 is a sectional view schematically illustrating the structure of the compressor 6 according to Embodiment 2.

The compressor 6 includes a motor 60 as an electric power element, a sealed or closed container 61 as a housing, and a compression mechanism 62 as a compression element. In this Embodiment, the compressor 6 is implemented as a rotary compressor. The compressor 6, however, is not limited to the rotary compressor.

The motor 60 is identical to the motor 1 according to Embodiment 1. In this Embodiment, the motor 60 is designed as an interior permanent magnet motor, but it is not limited to this.

The closed container 61 covers the motor 60 and the compression mechanism 62. Freezer oil to lubricate the sliding portions of the compression mechanism 62 is stored at the bottom of the closed container 61.

The compressor 6 further includes a glass terminal 63 fixed to the closed container 61, an accumulator 64, a suction pipe 65, and a discharge pipe 66.

The compression mechanism 62 includes a cylinder 62a, a piston 62b, an upper frame 62c (first frame), a lower frame 62d (second frame), and a plurality of mufflers 62e respectively mounted on the upper frame 62c and the lower frame 62d. The compression mechanism 62 further includes a vane to separate the cylinder 62a into the suction and compression sides. The compression mechanism 62 is driven by the motor 60.

The motor 60 is fixed in the closed container 61 by press fitting or shrink fitting. The stator 3 may be directly mounted in the closed container 61 by welding instead of press fitting and shrink fitting.

Power is supplied to the windings of the stator 3 of the motor 60 via the glass terminal 63.

The rotor (more specifically, one end side of the shaft 26) of the motor 60 is rotatably supported by a bearing provided on each of the upper frame 62c and the lower frame 62d.

The shaft 26 is inserted in the piston 62b. The shaft 26 is rotatably inserted in the upper frame 62c and the lower frame 62d. The upper frame 62c and the lower frame 62d close the end faces of the cylinder 62a. The accumulator 64 supplies a refrigerant (for example, a refrigerant gas) to the cylinder 62a via the suction pipe 65.

The operation of the compressor 6 will be described below. The refrigerant supplied from the accumulator 64 is drawn by suction into the cylinder 62a from the suction pipe 65 fixed to the closed container 61. As the motor 60 rotates by inverter power supply, the piston 62b fitted to the shaft 26 rotates in the cylinder 62a. With this operation, the refrigerant is compressed in the cylinder 62a.

The refrigerant ascends in the closed container 61 through the mufflers 62e. The compressed refrigerant is mixed with the freezer oil. As for the mixture of the refrigerant and the freezer oil, separation between the refrigerant and the freezer oil is accelerated upon their passage through holes formed in the rotor core, so that the freezer oil can be prevented from flowing into the discharge pipe 66. In this way, the compressed refrigerant is supplied to the high-pressure side of a refrigeration cycle through the discharge pipe 66.

As the refrigerant of the compressor 6, R410A, R407C, or R22, for example, can be used. The refrigerant of the compressor 6, however, is not limited to these examples. As the refrigerant of the compressor 6, a low-GWP (Global Warming Potential) refrigerant, for example, can be used.

As typical examples of the low-GWP refrigerant, the following refrigerants are available.

(1) An exemplary halogenated hydrocarbon having a carbon-carbon double bond in its composition is HFO-1234yf (CF3CF═CH2). HFO is an abbreviation of Hydro-Fluoro-Olefin. Olefin is an unsaturated hydrocarbon having only one double bond. The GWP of HFO-1234yf is 4.
(2) An exemplary hydrocarbon having a carbon-carbon double bond in its composition is R1270 (propylene). R1270 has a GWP of 3, which is lower than the GWP of HFO-1234yf, but R1270 is more flammable than HFO-1234yf.
(3) An exemplary mixture containing at least one of a halogenated hydrocarbon having a carbon-carbon double bond in its composition or a hydrocarbon having a carbon-carbon double bond in its composition is a mixture of HFO-1234yf and R32. Since HFO-1234yf is a low-pressure refrigerant and therefore causes a considerable pressure loss, it readily degrades the performance of the refrigeration cycle (especially in an evaporator). It is, therefore, desired to use a mixture with, for example, R32 or R41, which is a high-pressure refrigerant.

The compressor 6 according to Embodiment 2 has the effects described in Embodiment 1.

Using the motor 1 according to Embodiment 1 as the motor 60, the efficiency of the motor 60 can be improved, and the efficiency of the compressor 6 can be improved.

### Embodiment 3

An air conditioner 50 (also called a refrigerating and air conditioning apparatus or a refrigeration cycle apparatus) according to Embodiment 3 of the present invention will be described below.

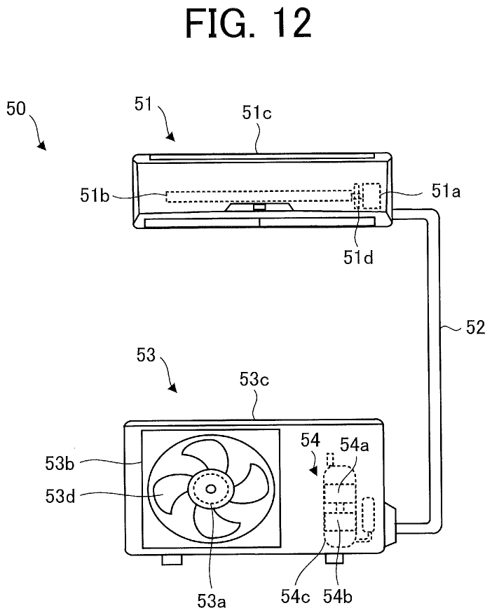

FIG. 12 is a diagram schematically illustrating the configuration of the air conditioner 50 according to Embodiment 3.

The air conditioner 50 according to Embodiment 3 includes an indoor unit 51 as a fan (first fan), refrigerant piping 52, and an outdoor unit 53 as a fan (second fan) connected to the indoor unit 51 via the refrigerant piping 52.

The indoor unit 51 includes a motor 51a (for example, the motor 1 according to Embodiment 1), an air blower 51b driven by the motor 51a to blow air, and a housing 51c to cover the motor 51a and the air blower 51b. The air blower 51b includes, for example, blades 51d driven by the motor 51a. The blades 51d, for example, are fixed to a shaft (for example, the shaft 26) of the motor 51a and generate an air current.

The outdoor unit 53 includes a motor 53a (for example, the motor 1 according to Embodiment 1), an air blower 53b, a compressor 54, and a heat exchanger (not illustrated). The air blower 53b is driven by the motor 53a to blow air. The air blower 53b includes, for example, blades 53d driven by the motor 53a. The blades 53d, for example, are fixed to a shaft (for example, the shaft 26) of the motor 53a and generate an air current. The compressor 54 includes a motor 54a (for example, the motor 1 according to Embodiment 1), a compression mechanism 54b (for example, a refrigerant circuit) driven by the motor 54a, and a housing 54c to cover the motor 54a and the compression mechanism 54b. The compressor 54 is identical to, for example, the compressor 6 described in Embodiment 2.

In the air conditioner 50, at least one of the indoor unit 51 or the outdoor unit 53 includes the motor 1 described in Embodiment 1. More specifically, as a driving source for the air blower, the motor 1 described in Embodiment 1 is applied to at least one of the motors 51a or 53a. As the motor 54a of the compressor 54, the motor 1 described in Embodiment 1 may even be used.

The air conditioner 50 can perform an operation such as a cooling operation for blowing cold air from the indoor unit 51, or a heating operation for blowing hot air from the indoor unit 51. In the indoor unit 51, the motor 51a serves as a driving source for driving the air blower 51b. The air blower 51b can blow conditioned air.

With the air conditioner 50 according to Embodiment 3, since the motor 1 described in Embodiment 1 is applied to at least one of the motors 51a or 53a, the same effects as those described in Embodiment 1 can be obtained. This makes it possible to improve the efficiency of the air conditioner 50.

Using the motor 1 according to Embodiment 1 as a driving source for a fan (for example, the indoor unit 51), the same effects as those described in Embodiment 1 can be obtained. This makes it possible to improve the efficiency of the fan. A fan including the motor 1 according to Embodiment 1 and blades (for example, the blades 51d or 53d) driven by the motor 1 can be solely used as an apparatus for blowing air. The fan is also applicable to apparatuses other than the air conditioner 50.

Using the motor 1 according to Embodiment 1 as a driving source for the compressor 54, the same effects as those described in Embodiment 1 can be obtained. This makes it possible to improve the efficiency of the compressor 54.

The motor 1 described in Embodiment 1 can be mounted not only in the air conditioner 50, but also in an apparatus including a driving source, such as a ventilating fan, a household electrical appliance, or a machine tool.

The features in the above-described embodiments can be combined together as appropriate.

1. A stator to be disposed outside a rotor to rotate around an axis, the stator comprising:
a stator core including a plurality of teeth and a plurality of slots that are adjacent to the plurality of teeth, respectively; and
a plurality of segment coils fixed to the stator core by wave winding,
the stator core including:
a first tooth of the plurality of teeth, the first tooth including a first main part extending in a first radial direction and a first end part located on an inner side with respect to the first main part in the first radial direction, the first end part extending in a circumferential direction; and
a second tooth of the plurality of teeth, the second tooth being adjacent to the first tooth and including a second main part extending in a second radial direction and a second end part located on an inner side with respect to the second main part in the second radial direction, the second end part extending in the circumferential direction,
wherein the plurality of slots are six times as many as magnetic poles of the rotor, and
in a plane perpendicular to the axis, a downstream side of the first end part in a rotation direction of the rotor is longer than an upstream side of the first end part in the rotation direction,
in the plane, a downstream side of the second end part in the rotation direction is longer than an upstream side of the second end part in the rotation direction, and
when a straight line passing through the axis and a center of an outer end of the first main part in the first radial direction in the plane is defined as L1, a straight line passing through the axis and a center of an outer end of the second main part in the second radial direction in the plane is defined as L2, and a straight line passing through the axis and a halfway point between the first end part and the second end part in the plane is defined as L3, and letting θ1 be an angle between the straight line L1 and the straight line L3 in the plane, and letting θ2 be an angle between the straight line L2 and the straight line L3 in the plane, the stator satisfies θ1>θ2.

2. The stator according to claim 1, wherein
a shape of the first end part is asymmetrical in the plane and
a shape of the second end part is asymmetrical in the plane.

3. The stator according to claim 1, wherein each of the plurality of teeth has an identical shape.

4. The stator according to claim 1, wherein the stator core comprises a recessed portion formed on an outer circumferential surface of the stator core.

5. The stator according to claim 1, wherein the stator core comprises a plurality of holes extending in an axial direction.

6. The stator according to claim 1, wherein the stator core has a maximum radius and a radius smaller than the maximum radius in the plane.

7. A motor comprising:
the stator according to claim 1; and
a rotor disposed inside the stator.

8. The motor according to claim 7, wherein
the rotor comprises a rotor core including a hole extending in an axial direction, and
ϕ/4≤r is satisfied, where ϕ is a diameter of the rotor core, and r is a distance from the axis to a center of the hole in the plane.

9. The motor according to claim 7, wherein the stator core comprises a recessed portion formed on an outer circumferential surface of the stator core.

10. A compressor comprising:
the motor according to claim 7;
a compression mechanism driven by the motor; and
a housing that covers the motor and the compression mechanism.

11. A refrigerating and air conditioning apparatus comprising:
an indoor unit; and
an outdoor unit connected to the indoor unit,
at least one of the indoor unit or the outdoor unit including the motor according to claim 7.
